(19) United States
(12) Patent Application Publication
(10) Pub. No.: US 2006/0203001 A1
(43) Pub. Date: Sep. 14, 2006

(54) Clipping of media data transmitted in a network

(76) Inventors: Petrus Desiderius Victor Van Der Stok, Eindhoven (NL); Mihaela Van Der Schaar, Martinez (NL); Christian Hentschel, Cottbus (DE)

Correspondence Address: PHILIPS INTELLECTUAL PROPERTY & STANDARDS, P.O. BOX 3001, BRIARCLIFF MANOR, NY, 10510, US

(21) Appl. No.: 10/539,360

(22) PCT Filed: Nov. 18, 2003
(86) PCT No.: PCT/IB03/05329

§ 371 Date: Jun. 15, 2005

(30) Foreign Application Priority Data
Dec. 18, 2002 (EP) 02080363.1

(51) Int. Cl. G09G 5/37

(52) U.S. Cl. 345/562

(57) ABSTRACT

The invention discloses an apparatus and a method for receiving multiple media data streams, which are displayed in separate windows of a multi-window display. Clipping information relating to an area of one of the windows being covered by the other window is transmitted to a source device providing the media data being covered when displayed. As a viewer may not see the covered area, the media data relating to the covered area is not needed by the destination device. Therefore, the source device based on the clipping information does not transmit any media data needed for processing of the covered area to the destination device, which does not have to process all media data relating to the covered area.

The invention relates to clipping of media data transmitted in a network, and more particularly to a method and an apparatus for clipping at least one of two media data streams transmitted in a network from a source device to a destination device for rendering in a multi-window display.

Media data, such as audio/video data, may be transmitted from a source device to a destination device, wherein the media data is processed to be displayed on a screen. However, interconnecting different electronic equipment, such as a video player, a digital video disk (DVD) player, a personal computer (PC), etc., capable of providing a media data stream in a local area network, such as a home network, is becoming increasingly common. The local area network may in turn be operatively connected to a wide area network to which even more source devices providing media data streams are operatively connected.

Interconnecting the source devices and at least one destination device in a network provides the possibility to display a number of media data streams in different windows of a single multi-window display operatively connected to the destination device. A first media data stream is e.g. provided by a video recorder and a second media data stream is provided by a PC. It may happen that the first media data stream is displayed in a first window as a main image covering the complete display area, and that the second media data stream is displayed in a second window as a picture in the picture (PiP) window covering parts of the first window. Consequently, those parts of the first window being overlapped by the second window are invisible to a viewer. Further, if the destination device receives multiple media data streams this may happen for several of the associated windows displayed in the multi-window display.

In the network, the available capacity or bandwidth for transmitting data is limited. Transmitting several media data streams from one or several source devices to a destination device requires a certain amount of bandwidth. However, if some amount of the displayed media data stream is displayed in a window area covered by other windows bandwidth is wasted, as the covered area of the window is invisible. Thus, there is a need for a method and an apparatus for more efficiently transmitting media data streams, which will be displayed in a multi-window display.

It is an object of the invention to save bandwidth in a network when multiple media data streams are transmitted from one or several source devices to at least one destination device, wherein the media data streams are rendered in different windows of a multi-window display.

The above object is achieved by a method and an apparatus for receiving multiple media data streams to be displayed in different windows of a multi-window display of a destination device. According to the method, clipping information of at least one of the received media data streams being at least partly covered when displayed in a first window of the multi-window display are calculated by the destination device. A second window displaying a second media data stream is covering the first window. Consequently, as the covered part of any window can not be seen by a viewer, the media data relating to the covered part is not needed in the destination device. Therefore, the clipping information is transmitted to the source device providing the media data stream displayed in the at least partly covered window. When the source device has clipped the media data stream based on the clipping information and possibly stored image processing information, the destination device receives a clipped media data stream to be displayed in the first window.

A method and apparatus for transmitting media data to a destination device also achieve the above object. According to the invention an apparatus, such as a source device, receives clipping information provided by at least one destination device displaying a media data stream. The source device is configured to calculate a window area for which media data is not needed by the destination device, said area is a part of a first window of a multi-window display being covered by a another window. The apparatus is further configured to not provide any media data relating to the calculated area to the destination device, wherein only a clipped media data stream is provided to the destination device.

These and other aspects of the invention will be apparent from and elucidated with reference to the embodiments described hereinafter.

The invention will now be described, by way of example, with reference to the accompanying drawings, wherein:

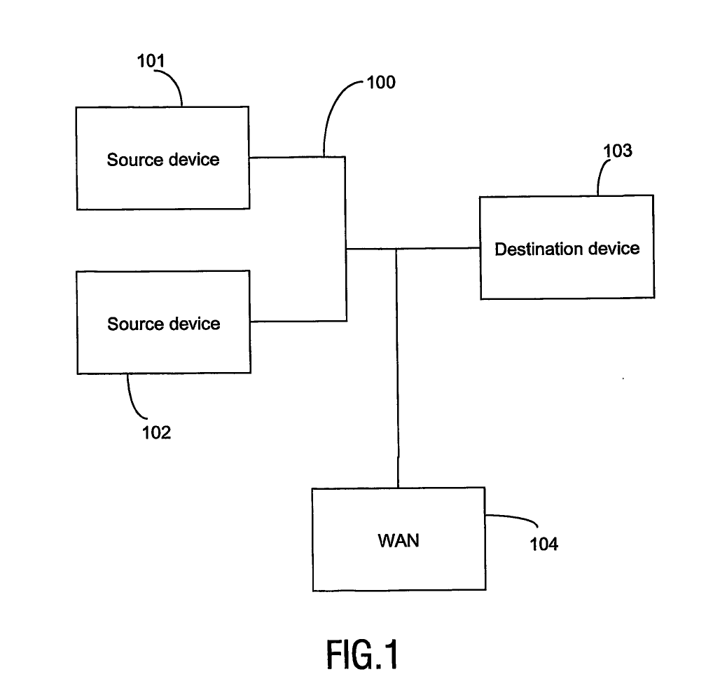

FIG. 1 illustrates a number of source devices connected to a destination device via a network;

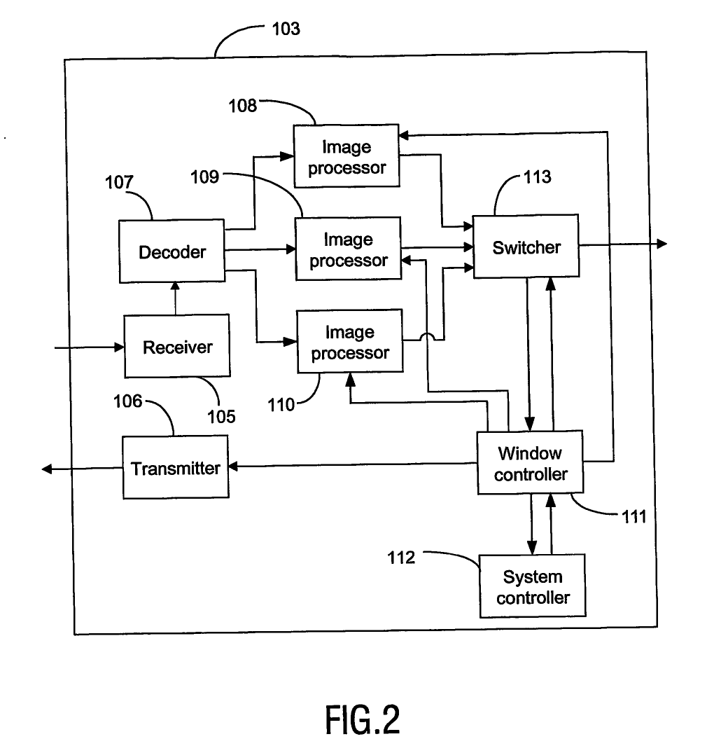

FIG. 2 illustrates one embodiment of a destination device for implementing the present invention;

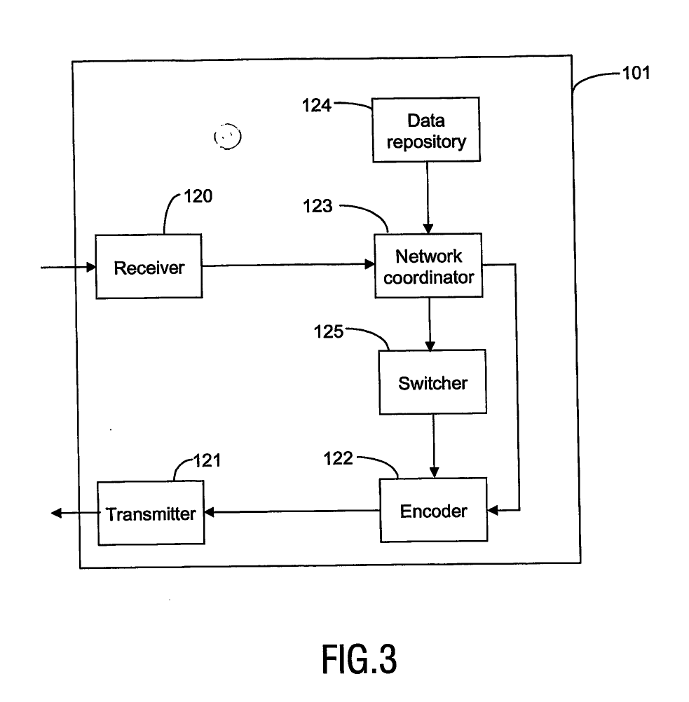

FIG. 3 illustrates one embodiment of a source device for implementing the present invention;

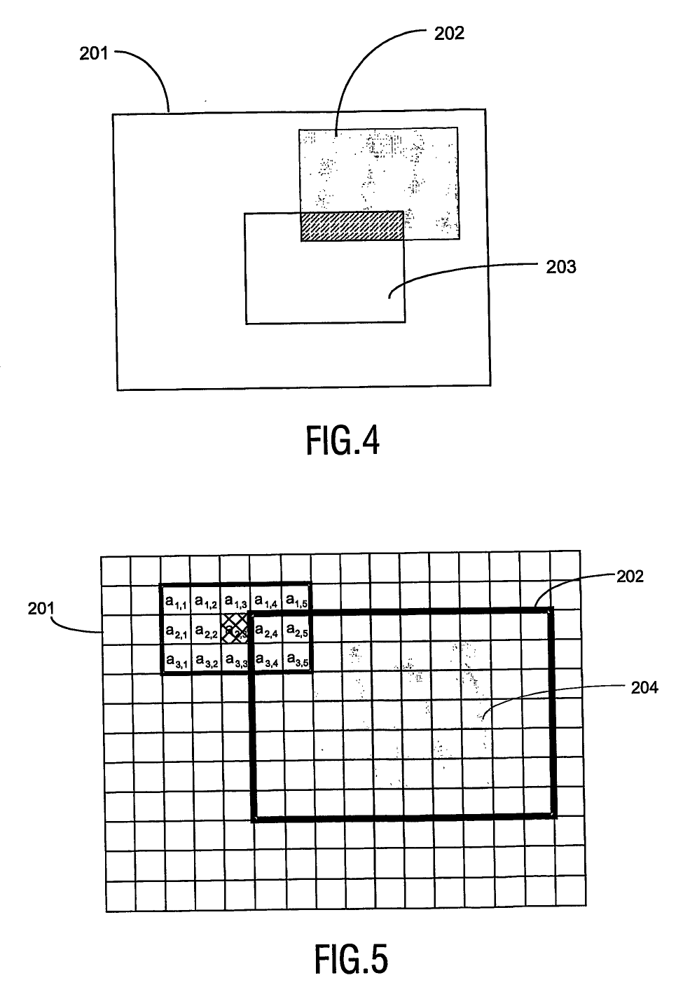

FIG. 4 illustrates a main window partly covered by two PiP windows;

FIG. 5 illustrates pixels involved for processing an output pixel of a window;

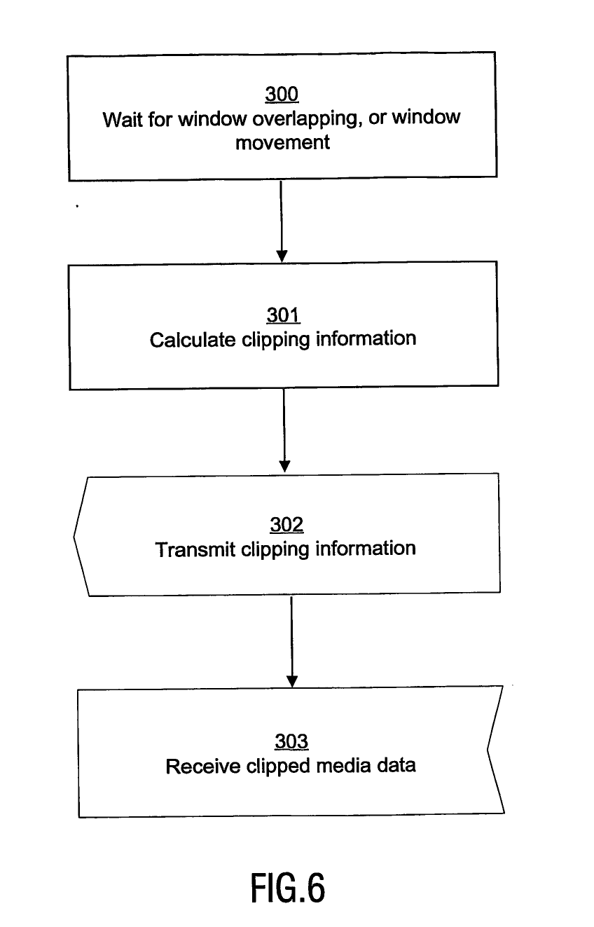

FIG. 6 is a flow chart of a first method according to the invention; and

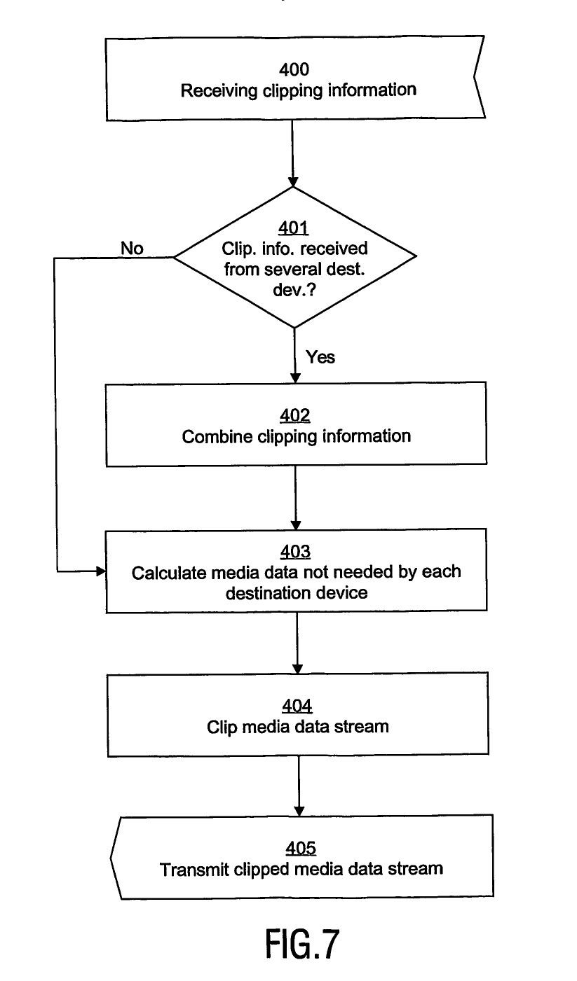

FIG. 7 is a flow chart of a second method according to the invention.

Processing of media data, such as digital audio/video data, is well known in image processing. A media data stream may be transmitted from several source devices operatively connected in a network, said media data streams being received by one or several destination devices operatively connected to the network. The network may be a local area network, such as a home network, which in turn is connected to a wide area network such as the Internet. If each received media data stream is to be displayed in a separate window of a multi-window display, one window may overlap the other. According to the invention, at least parts of the media data covered when displayed in a window of the multi-window display need not be transmitted by the source device to the destination device. This is possible as media data algorithms are usually processed independently of their appearance on the final display. In a multi-window environment, this leads to at lot of unnecessary processing in the hidden areas. By utilizing the method according to the invention, transmitting and processing media data not being rendered is avoided.

FIG. 1 is a schematic illustration of a local area network (LAN) 100 for operatively connecting a number of source devices 101, 102 to at least one destination device 103. In FIG. 1 only two source devices are illustrated. However, any number of source devices 101, 102 maybe connected to the network. The source devices 101, 102 comprise e.g. DVD players, personal computers, media servers and/or video players, each providing a different media data stream, such as a video stream, to be received by the destination device 103, such as a set top box, or a personal computer. The local area network 100 may be operatively connected to a wide area network (WAN) 104, such as the Internet, to which further source devices for providing media data streams may be operatively connected. In an alternative embodiment, the LAN 100 is not provided, wherein the destination device 103 is only connected to source devices connected to the WAN 104.

FIG. 2 is a block diagram of one embodiment of the destination device 103 according to the invention. The destination device is configured to receive multiple media data streams from one or several source devices 101, 102. The destination device comprises a receiver 105 configured to receive media data streams from one or several source devices 101, 102 via the LAN 100 and/or the WAN 104. Further, the destination device 103 comprises a transmitter 106 operatively connected to the LAN 100 and/or the WAN 104 for transmitting clipping information to the source devices 101, 102 providing media data streams, as will be further described in the following. A decoder block 107 is operatively connected to the receiver 105. The decoder block 107 is configured to decode the media data stream using video coding schemes, such as MPEG-4 FGS (Moving Pictures Experts Group 4 Fine Grain Scalability), DCT (Discrete Cosine transform), and wavelet coding. However, it is equally possible to use other video coding schemes within the scope of the invention. The decoder block 107 is operatively connected to a number of image processors. In the embodiment shown in FIG. 2, the destination device 103 comprises a first, a second, and a third image processor 108, 109, 110 that are configured to process a first, a second, and a third media data stream, respectively. However, the destination device 103 may comprise any number of image processors capable of processing at least two different media data streams and is not limited to the number shown, which is only for exemplifying purposes. Each image processor 108, 109, 110 are operatively connected to a window controller 111, which in turn is operatively connected to a system controller 112, such as the central processing unit (CPU) of the destination device 103. The image processors 108, 109, 110 are operatively connected to a switcher 113, which is configured to generate an output media data stream comprising a multi-window image based on the processed media data streams provided by the first, second, and third image processors 108, 109, 110, respectively. Further, the window controller 111 is also operatively connected to the switcher 113 for extracting display coordinates and providing the clipping information, as will be further described in the following. The window controller 111 may in an alternative embodiment be provided as an integral part of the switcher 113.

FIG. 3 is a block diagram of components of the source device 101, 102, which are involved for carrying out the invention. As is understood, the exemplifying source device is not limited to the components shown in FIG. 3, but may comprise other components as well. The source device 101, 102 comprises a receiver 120 configured to receive clipping information from at least one destination device 103. Also, the source device comprises a transmitter 121 for transmitting an encoded media data stream to the destination device 103. The transmitter 121 is operatively connected to an encoder block 122 being configured to encode media data according to video coding schemes such as MPEG-4 FGS (Moving Pictures Experts Group 4 Fine Grain Scalability), DCT (D)iscrete Cosine Transform), and wavelet coding. The encoder block 122 is operatively connected to a network coordinator 123, which is configured to coordinate clipping information received from any number of destination devices. Also, the network coordinator is configured to calculate, based on the received clipping information and stored image processing information, the media data that is not needed by at least one destination device 103, and configured to clip at least one media data stream accordingly. A processor, having stored image processing information to carry out the steps according to the method of the invention may be utilized to implement the network coordinator 123. The network coordinator 123 is operatively connected to a media data repository 124 configured to store media data. The media data repository 124 may e.g. be implemented as a memory, such as a hard disk, an optical disk, a video tape, a magnetic tape, or a magnetic disk comprising media data to be processed and transmitted to the destination devices 103 as a media data stream.

In an alternative embodiment, the source device 101, 102 also comprises a switcher 125 operatively connected to the network coordinator 123 and to the encoder block 122. The switcher 125 is configured to combine a clipped media data stream with at least a second media data stream to a multi-window image comprising at least two windows. The display coordinates of each window of the multi-window is received from the destination device 103.

The invention will now be further explained in relation to some exemplifying embodiments. Multiple media data streams are transmitted from one or several source devices 101, 102 to one or several destination devices 103. Each media data stream will be received by the receiver 105 of the destination device 103, decoded by the decoder block 107 and forwarded to respective image processors 108, 109, 110, which will generate images that are joined by the switcher 113 to be displayed on a multi-window display in different windows.

FIG. 4 illustrates a multi-window display comprising a main window 201 rendering a media data stream processed by e.g. the first image processor 101. Also, the multi-window display comprises first and second picture in picture (PiP) windows 202, 203 overlapping the main window 201. The second PiP window 203 may also partly overlap the first PiP window 202, or vice versa, as is indicated with a cross-hatched field in FIG. 4. A second media data stream is processed by e.g. the second image processor 109 and viewed in the first PiP window 202. Further, a third media data stream processed by e.g. the third image processor 110 is viewed in the second PiP window 203. The same or different source devices 101, 102 may transmit each media data stream.

As can be seen in FIG. 4, the first and second PiP windows 202, 203 are covering portions of the main window 201. It is therefore according to the invention not necessary for the first image processor 108 to process all media data for those areas of the main window being covered. Also, the second PiP window 203 is covering portions of the first PiP window 202.

FIG. 5 illustrates the main window 201 and the first PiP window 202. To view media data in a certain pixel of a display it may be necessary to consider relationships between pixels in an image. As is illustrated in FIG. 5, a matrix of pixels a_{1,1}-a_{3,5} may be involved for processing the cross-hatched center pixel a_{2,3}. Consequently, although pixels a_{2,4}, a_{2,5}, a_{3,4} and a_{3,5} are covered by the PiP window 202 it is in this case necessary to both transmit and process media data information for said covered pixels. However, any media data relating to any pixel not involved in the processing of a visible pixel, such as the shaded area 204, is not needed by the destination device 103. In an alternative embodiment, there may be no relationship between neighboring pixels, wherein media data for any covered area is not needed by the destination device 103. In one embodiment according to the invention, media data is transmitted in a base layer and an enhancement layer. In the enhancement layer, for the calculation of pixel a_{2,3} media data is needed only for a_{2,3}. However, in the base layer for the calculation of the pixel a_{2,3}, media data are needed for all pixels from a_{1,1} to a_{3,5}.

For providing relevant clipping information to a specific source device 101, 102 it is necessary to know where in the multi-window display overlap occurs, i.e. the relevant display coordinates. A viewer of the images presented in the main window 201 and the PiP windows 202, 203 can determine the size and position of each PiP window on the multi-window display, by e.g. sending a message to the system controller 112 of the destination device 103 using e.g. a remote control or a mouse. In one embodiment, the system controller 112 generates the demanded display coordinates for each window, which are forwarded to the switcher 113, possibly via the window controller 111. The switcher is configured to join the main window 201 generated by e.g. the first image processor 108 and the PiP windows 202, 203 generated by e.g. the second and third image processors 109, 110, respectively. The system controller 112 verifies by means of the window controller 111 whether overlaps between any of the windows 201, 202, 203 occur, wherein the window controller 111 extracts the display coordinates of the overlapped area(s), said coordinates being transmitted to the image processors 108, 109, 110. Also, the image processors 108, 109, 110 have image processing information of whether any neighboring pixels are involved in the processing of an output pixel. This processing information is known by the destination device 103, or communicated from the source device 101, 102 to the system controller 112. The processing information is e.g. stored in a register of the system controller 112. Consequently, the image processors 108, 109, 110 can determine the pixels, for which processing of media data is not to be executed, and for which media data is not necessary. Further, the display coordinates of the overlapped area(s) are also transmitted by the transmitter 106 to each source device 101, 102 providing the media data being overlapped when displayed in a window 201, 202, 203.

In an alternative embodiment, the original or previous window coordinates of the covered area(s) are adjusted by the window controller 111 taking the overhead areas, i.e. areas involved in processing a shown pixel but not shown in itself, into account. Then, the adjusted window coordinates of the covered area(s), such as the shaded area 204, are transmitted to the source device 101, 102 via the transmitter 106.

As can be seen in the example of FIG. 4, both the main image 201 and the first PiP image 202 are covered to a certain amount. Therefore, clipping information will be generated for each media data stream to be transmitted to the source device proving the media data streams displayed in the main image 201 and the first PiP image 202, respectively. As is appreciated, the present invention is not limited to one main window 201 and two PiP windows 202, 203, but any number of PiP windows 202, 203 overlapping each other and the main window 201 to a certain amount is possible within the scope of the invention.

Every time the user of the destination device 103 moves a window 201, 202, 203, or changes the size of said windows, new areas will be covered and others uncovered, wherein new clipping information is re-calculated and transmitted to the source devices 101, 102, and the image processors 108, 109, 110 concerned. Preferably, the clipping information is generated and transmitted to the concerned source device 101, 102 within a maximum time interval of a few hundred milliseconds. If the clipping information is provided with a high enough frequency, no synchronization problems between the source device 101, 102 and the destination device 103 will occur, as both the source devices 101, 102 and the image processors 108, 109, 110 of the destination device 103 have window coordinates and both can calculate the coordinates of the covered areas. Consequently, the calculation of the covered area by the source device 101, 102 will not lag behind the actual covered area at the destination device 103.

In an alternative embodiment, synchronization problems between the source device 101, 102, and the destination device 103 can be avoided although the clipping information is not generated and transmitted within the above-mentioned interval. In this embodiment, the clipping information is first generated by the destination device 103, such as set out above, and transmitted to the source device 101, 102. The clipping information is also transmitted to the image processors 108, 109, 110, which in this embodiment are set to not apply the new clipping information until an acknowledgement that the clipping information has been applied by the source device 101, 102 is received. The processors 108, 109, 110 will wait until the acknowledgement is received. When the source device 101, 102 receives the clipping information, it will act on said clipping information as will be described in the following. Additionally, the source device 101, 102 will prepare and transmit an acknowledgement together with the clipped media data stream to the destination device 103 concerned. In one embodiment, the clipping information will act as an acknowledgement. Alternatively a separate acknowledgement that the clipping information is received and applied may be generated and transmitted. When the destination device 103 receives the acknowledgement, the image processors 108, 109, 110 may start applying the new clipping information.

A certain source device 101, 102 may serve one or several destination devices by multicasting or unicasting media data streams. When multicasting is provided, the source device 101, 102 may receive clipping information from each destination device that receives at least one media data stream from said source device, as described above. In a multicasting environment, the network coordinator 123 of the source device 101, 102 combines the clipping information received from each operatively connected destination device 103, calculates the area of a window being covered in all destination devices and clips those parts of the media data stream not being needed by anyone of the destination devices accordingly. Consequently, in a multicasting environment the network coordinator retrieves the media data from the media data repository 124 and clips said media data using the combined clipping information before transmitting the media data stream to each connected destination device 103. As is understood, one source device 101, 102 may provide several media data streams, wherein it is configured to receive clipping information from one or several destination devices relating to each media data stream provided.

In a unicasting environment, the source device 101, 102 is configured to clip each media data stream transmitted to a specific destination device 103 differently according to received clipping information from that destination device. Consequently, in the unicasting environment the network coordinator 123 does not have to combine the clipping information received from different destination devices 103. The media data stream retrieved from the media data repository 124 is only clipped according to clipping information received from a specific destination device 103.

The source devices 101, 102 will act on clipping information by e.g. removing data relating to the area calculated by the network coordinator 123 from the media data packets of the media data stream transmitted to the destination device 103. In the preferred embodiment of the invention, full transmission of the base layer is provided. However, enhancement media data blocks of the enhancement layer relating to the media data not needed by the destination device 103 will not be transmitted to the destination device. The media data blocks not transmitted are extracted based on the calculation provided by the network coordinator 123, as described above. In another embodiment, the encoder block 122 of the source device 101, 102 may be set, e.g. by the network coordinator 123, to not encode and transmit the enhancement media data blocks of the enhancement layer relating to the media data not needed by the destination device, which is calculated by the network coordinator 123.

FIG. 6 comprises one embodiment of the steps of the inventive method carried out in the destination device 103 for providing clipping information to the source device 101, 102, and receive a clipped media data stream. In a first step 300 the system waits for an initiation of a calculation of clipping information. This is initiated in that the switcher 113 verifies that there are at least one window overlapping another in the multi-window display or that a movement of one out of several windows has been commenced. In step 301 the display coordinates for each overlapping area are calculated by the window controller 111. The display coordinates of an overlapping area is e.g. a function f(x,y) comprising the relevant display coordinates. This step is repeated for every window, which is at least partly overlapped by another window. In step 302, the clipping information is transmitted to the concerned source device. In step 303 the clipped media data stream is received from the source device 101, 102, wherein the stream is processed by utilizing stored image processing information and the clipping information to provide an image comprising an area, which is not processed.

When the clipped media data stream is received by the destination device 103, the media data stream is decoded and it is determined which pixels are not to be processed to derive the output data stream supplied to the switcher 113. Then, the clipped media data stream may be processed and outputted to the switcher 113 producing an output media stream comprising a multi-window image. However, if the source device 101, 102 provides a complete multi-window image, the clipped media-data streams do not have to be processed by the destination device, wherein the received clipped media data stream only has to be decoded before outputted as an output media data stream. In an embodiment wherein the source device 101, 102 prepares the multi-window image, the destination device may not comprise any image processors 108, 109, 110.

FIG. 7 illustrates the steps according to one embodiment executed by the source device 101, 102 for handling the clipping information and providing a clipped media data stream. In step 400 the source device 101, 102 receives the clipping information, which initiates clipping of a media data stream. In step 401 it is determined whether clipping information is received from multiple destination devices. If the answer in step 401 is affirmative, all received clipping information is in step 402 combined to combined clipping information. However, if unicasting is provided, this step may be discarded. If new clipping information, or updated clipping information is received from one or several connected destination devices the new clipping information is combined with stored clipping information received from another destination device previously. Then, in step 403 stored image processing information and the combined clipping information, or possibly each clipping information if the answer in step 401 is negative, is utilized for calculating media data not needed by the destination devices, which hence does not have to be transmitted to the destination device 103.

In one embodiment, in step 404 the media data stream is clipped in that data blocks relating to the media data not needed by the destination device are removed from the media data stream transmitted to the destination device 103. In another embodiment, in step 404 the media data stream is clipped in that the encoder block 122 is instructed not to encode the blocks relating to said not needed media data. Finally in step 405, the clipped media data stream is encoded and transmitted to the destination device 103 that provided the clipping information being utilized for clipping the media data stream, or to each connected destination device in a multicasting environment.

In the embodiment wherein one source device 101, 102 provides a preprocessed clipped multi-window image, the network coordinator 123 provides several media data streams, of which at least one is clipped, based on received clipping information. Then the clipped media data stream and the at least one other media data stream are combined to a multi-window image, which is encoded and transmitted in step 405.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality, and a single processor or other unit may fulfill the functions of several of the units or circuits recited in the claims.

1. A method for receiving multiple media data streams to be displayed in separate windows of a multi-window display of a destination device, comprising the steps of:
providing clipping information of a covered area of a first window of the multi-window display, said first window being at least partly covered by at least a second window of the media multi-window;
transmitting the clipping information to a source device providing a first media data stream rendered in the first window; and
receiving a clipped media data stream comprising media data for an uncovered area of the first window.

2. The method according to claim 1, wherein the clipping information comprises at least display coordinates of the second window.

3. The method according to claim 1, wherein the step of providing further comprises the step of:
extracting display coordinates of at least the second window of the multi-window display.

4. The method according to claim 1, further comprising the steps of:
re-calculating the clipping information in response to a movement or a change of size of the first or the at least second window; and
transmitting the re-calculated clipping information.

5. The method according to claim 1, wherein the received clipped media data steam comprises a full media data base layer, and a clipped media data enhancement layer, said media data enhancement layer only comprises media data blocks needed for processing the uncovered area of the first window.

6. The method according to claim 1, further comprising the steps of:
decoding the received clipped media data stream; and
processing the clipped media data stream based on the clipping information and stored processing information

7. The method according to claim 1, wherein the received clipped media data stream comprises a clipped preprocessed multi-window image.

8. The method according to claim 1, wherein the step of providing clipping information comprises the further step of:
setting at least one image processor to wait for an acknowledgement that the clipping information has been applied by the source device; and
the step of receiving a clipped media data stream comprises the further step of:
receiving an acknowledgement that the clipping information has been applied.

9. The method according to claim 1, wherein the media data stream comprises audio/video data blocks.

10. A method for transmitting a media data stream from a source device to at least one destination device, comprising the steps of;
receiving clipping information from at least one destination device;
calculating a window area for which media data is not needed by the at least one destination device based on the received clipping;
clipping the media data stream according to the calculated area to provide a clipped media data stream; and
transmitting the clipped media data stream to the at least one destination device.

11. The method according to claim 10, wherein the clipping information comprises display coordinates of at least one window covering another window in a multi-window display.

12. The method according to claim 10, wherein the step of calculating further comprises the step of:
calculating an window area for which media data is not needed by anyone of several destination devices.

13. The method according to claim 10, wherein clipping information received from multiple destination devices are handled separately.

14. The method according to claim 10, wherein the step of clipping further comprises the step of:
removing from the media data stream enhancement media data blocks of an enhancement layer relating to the calculated window area.

15. The method according to claim 10, wherein the step of clipping further comprises the step of:
setting an encoder to not encode enhancement media data blocks of an enhancement layer relating to the calculated window area.

16. The method according to claim 10, wherein the step of clipping further comprises the step of:
joining a first clipped media stream and at least a second media data stream to a multi-window image.

17. The method according to claim 10, wherein the step of transmitting further comprises the steps of:
preparing an acknowledgement that the received clipping information is applied; and
transmitting the acknowledgement to the destination device concerned.

18. The method according to claim 17, wherein the acknowledgement is the received clipping information.

19. The method according to claim 10, wherein the media data stream comprises audio/video data blocks.

20. An apparatus for receiving media data, comprising:
means for receiving multiple media data streams to be displayed in at least two separate windows of a multi-window display; and
means for providing clipping information comprising information relating to at least one covered area of at least one of the at least two windows being covered by at least the other of the at least two windows; and
means for transmitting the clipping information to at least one source device, said means for transmitting is operatively connected to said means for providing.

21. The apparatus according to claim 20, further comprising:
means for processing at least two media data streams operatively connected to the means for receiving; and
means for joining the at least two processed media data streams to an output media data stream for rendering in the multi-window display, said means for joining is operatively connected to the means for processing.

22. The apparatus according to claim 21, wherein the means for processing is at least one image processor configured to process the media data streams according to stored image processing information, and according to the clipping information derived by the means for deriving.

23. An apparatus for transmitting a media data stream to at least one destination device, comprising;
means for receiving clipping information from at least one destination device;
means for clipping the media data stream based on the received clipping information, said means for clipping being operatively connected to said means for receiving; and
means for transmitting the clipped media data to at least one destination device.

24. The apparatus according to claim 23, further comprising means for encoding the clipped media data stream.
